(19) United States
(12) Patent Application Publication
(10) Pub. No.: US 2024/0230413 A1
(43) Pub. Date: Jul. 11, 2024

(54) INFRARED SENSOR AND ITS REFERENCE ELEMENT AND MANUFACTURING METHOD OF THE REFERENCE ELEMENT

(71) Applicant: INDUSTRIAL TECHNOLOGY RESEARCH INSTITUTE, Hsinchu (TW)

(72) Inventors: Chin-Jou KUO, Tainan City (TW); Bor-Shiun LEE, New Taipei City (TW); Ming-Fa CHEN, Taoyuan City (TW); Kun-Chuan LIN, Tainan City (TW)

(73) Assignee: INDUSTRIAL TECHNOLOGY RESEARCH INSTITUTE, Hsinchu (TW)

(21) Appl. No.: 18/094,334

(22) Filed: Jan. 6, 2023

(51) Int. Cl. G01J 5/06; G01J 5/02; G01J 5/04; G01J 5/30

(52) U.S. Cl. CPC G01J 5/064; G01J 5/024; G01J 5/046; G01J 5/30

(57) ABSTRACT

A reference element of an infrared sensor includes a substrate, a sacrificial layer, a supporting structure, a fence structure and an infrared sensing structure. The sacrificial layer is disposed on the substrate. The supporting structure is disposed on the substrate wherein the top surface of the supporting structure is coplanar with the top surface of the sacrificial layer. The fence structure is disposed on the substrate and surrounds the sacrificial layer wherein the top surface of the fence structure is coplanar with the top surface of the sacrificial layer, and there is an air gap between the fence structure and the supporting structure. The infrared sensing structure is disposed on the sacrificial layer, the supporting structure and the fence structure, and the infrared sensing structure has an opening corresponding to the air gap.

### BACKGROUND

### 1. Technical Field

This disclosure relates to a reference element of an infrared sensor.

### 2. Related Art

An infrared sensing element can absorb infrared emitted from objects and transform the energy of infrared light into heat energy, and the heat energy can make the temperature of the sensing element rise so as to change the resistance of the sensing material. Therefore, a goal of measuring temperature can be achieved through the infrared sensing element.

While the resistance output of the infrared sensing element is related to the temperature of the substrate and the temperature difference between the substrate and the element, the temperature of the object to be measured is mainly reflected in the temperature difference between the substrate and the element. In other words, the resistance output of the infrared sensing element can only reflect the temperature of the sensing element instead of telling the temperature difference between the substrate and the element.

The current reference element can be implemented as a sensing structure that is covered to refrain the sensing structure from being irradiated by the infrared light so that the resistance of the reference element can present the substrate temperature. However, this way requires an additional covering process which may be more costly and challenging. Alternatively, the reference element can be implemented as a sensing structure directly contacted with the substrate without an air gap to achieve thermal equilibrium with the substrate. However, the height difference between the reference element and the sensing element may cause a difference between electrical signal paths of the reference element and those of the sensing element and make the overall uniformity of the whole sensor more uncontrollable.

### SUMMARY

According to one or more embodiments of this disclosure, a reference element of an infrared sensor includes a substrate, a sacrificial layer, a supporting structure, a fence structure and an infrared sensing structure. The sacrificial layer is disposed on the substrate. The supporting structure is disposed on the substrate wherein the top surface of the supporting structure is coplanar with the top surface of the sacrificial layer. The fence structure is disposed on the substrate and surrounds the sacrificial layer with the top surface of the fence structure coplanar with the top surface of the sacrificial layer, and there is an air gap between the fence structure and the supporting structure. The infrared sensing structure is disposed on the sacrificial layer, the supporting structure and the fence structure, and the infrared sensing structure has an opening corresponding to the air gap.

According to one or more embodiments of this disclosure, an infrared sensor includes a reference element and a sensing element. The reference element includes a first substrate, a sacrificial layer, a first supporting structure, a fence structure and a first infrared sensing structure. The sacrificial layer is disposed on the first substrate. The first supporting structure is disposed on the first substrate with the top surface of the first supporting structure coplanar with the top surface of the sacrificial layer. The fence structure is disposed on the first substrate and surrounds the sacrificial layer wherein the top surface of the fence structure is coplanar with the top surface of the sacrificial layer, and there is an air gap between the fence structure and the first supporting structure. The first infrared sensing structure is disposed on the sacrificial layer, the first supporting structure and the fence structure, and the first infrared sensing structure has an opening corresponding to the air gap. The sensing element includes a second substrate, a second supporting structure and a second infrared sensing structure. The second supporting structure is disposed on the second substrate. The second infrared sensing structure is disposed on the second supporting structure, wherein the first infrared sensing structure and the second infrared sensing structure are coplanar with each other.

According to one or more embodiments of this disclosure, a manufacturing method of the reference element of the infrared sensor includes forming a sacrificial layer on a substrate; embedding a supporting structure and a fence structure into the sacrificial layer wherein the top surface of the sacrificial layer, the top surface of the supporting structure and the top surface of the fence structure are coplanar with each other; forming an infrared sensing structure on the sacrificial layer, the supporting structure and the fence structure; and forming an opening in an area of the infrared sensing structure corresponding to an area between the supporting structure and the fence structure to release a part of the sacrificial layer between the supporting structure and the fence structure.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 illustrates a stereoscopic structure of a reference element of an infrared sensor according to an embodiment of the present disclosure;

FIG. 2 illustrates a schematic top view of a reference element according to an embodiment of the present disclosure;

FIG. 3 illustrates a schematic cross-section view of the reference element taken along a line A-A′ shown in FIG. 2 according to an embodiment of the present disclosure;

FIG. 4 is a flow chart of the manufacturing method of the reference element according to an embodiment of the present disclosure;

FIG. 5 illustrates a schematic state of the reference element according to step S10 shown in FIG. 4;

FIG. 6 illustrates a schematic state of the reference element according to step S20 shown in FIG. 4;

FIG. 7 illustrates a schematic state of the reference element according to step S30 shown in FIG. 4;

FIG. 8 and FIG. 9 illustrate two schematic states of the reference element according to step S40 shown in FIG. 4;

FIG. 10 illustrates a schematic top view of an infrared sensor according to an embodiment of the present disclosure;

FIG. 11 illustrates a schematic cross-section view of a sensing element of an infrared sensor taken along a line B-B′ shown in FIG. 10 according to an embodiment of the present disclosure; and

FIG. 12 illustrates a relationship between the temperature to be measured and the readout voltage under the circumstance that the reference element according to an embodiment of the present disclosure is used or not.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

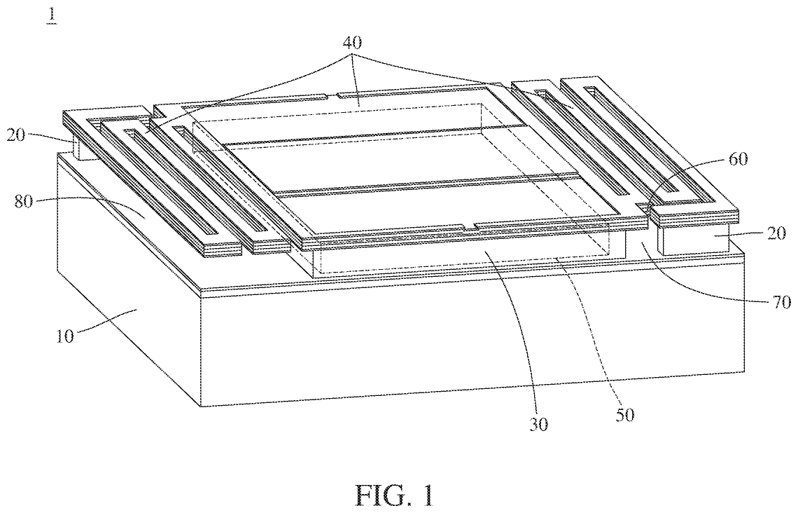

Please refer to FIG. 1 which illustrates a stereoscopic structure of a reference element of an infrared sensor according to an embodiment of the present disclosure. In the present embodiment, the reference element 1 includes a substrate 10, a supporting structure 20, a fence structure 30, an infrared sensing structure 40 and a sacrificial layer 50. The supporting structure 20 and the fence structure 30 are disposed on the substrate 10, the fence structure 30 surrounds the sacrificial layer 50, and the top surface of the supporting structure 20, the top surface of the fence structure 30 and the top surface of the surrounded sacrificial layer 50 are coplanar with each other. The infrared sensing structure 40 is disposed on the sacrificial layer 50, the supporting structure 20 and the fence structure 30, and the infrared sensing structure 40 has an opening 60 corresponding to an air gap 70 which is between the fence structure 30 and the supporting structure 20. As illustrated in FIG. 1, the reference element 1 may further optionally include a reflective layer disposed on the substrate 10. In the present embodiment, for example, the substrate 10 may be but is not limited to a silicon substrate with a circuit structure such as a reading circuit structure. The supporting structure 20 may be made of a conductive material, such as metal but is not limited to this. The supporting structure 20 may be electrically connected to the circuit structure in the infrared sensing structure 40 and the substrate 10. The supporting structure 20 may be made of a conductive material such as a metal pillar. The fence structure 30 may be made of a conductive material, such as a metal material but is not limited to this. The infrared sensing structure 40 may be stacked up above the substrate 10 and the reflective layer 80 by the supporting structure 20, the fence structure 30 and the sacrificial layer 50. For example, the infrared sensing structure 40 may include but is not limited to a plurality of infrared absorbing layers, an infrared sensing layer and a sensing electrode, and the structure of the infrared sensing structure 40 is described in detail in the following description. It should be noted that FIG. 1 merely demonstrates the pattern of the infrared sensing structure 40 in an illustrative way, and the pattern of the infrared sensing structure 40 is not limited thereto. FIG. 1 exemplarily shows that there are a plurality of supporting structures 20 disposed on the substrate 10, wherein the number of the supporting structures 20 may be but is not limited to two. The reflective layer 80 may be but is not limited to, for example, a metal film capable of reflecting infrared.

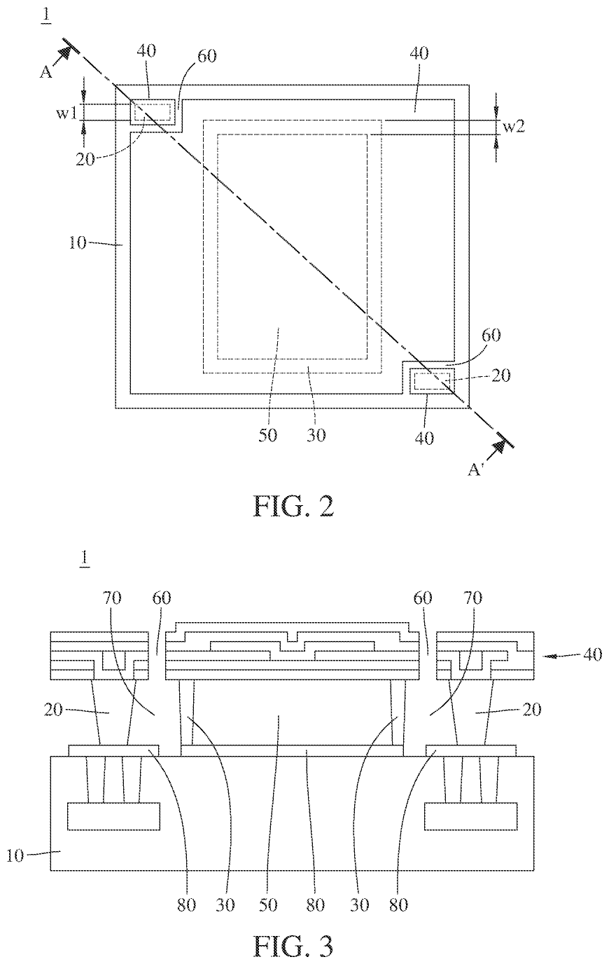

Please refer to FIG. 2 which illustrates a schematic top view of a reference element according to an embodiment of the present disclosure. As shown in FIG. 2, the reference element 1 is formed on the basis of forming the supporting structures 20, the fence structure 30, the infrared sensing structure 40 and the sacrificial layer 50 on the substrate 10. The fence structure 30 may be but is not limited to a rectangle structure to surround the sacrificial layer 50 inside to prevent the sacrificial layer 50 from being released during the releasing process. More particularly, the width w1 of the top surface of each of the supporting structures 20 may equal the width w2 of the top surface of the fence structure 30. It should be noted that FIG. 2 illustrates the infrared sensing structure 40 and the openings 60 in a simplified way, but the actual configuration is that a part of the infrared sensing structure 40 located on the supporting structure 20 is electrically connected to another part of the infrared sensing structure 40 located on the fence structure 30 as shown in FIG. 1.

Please refer to FIG. 3 which illustrates a schematic cross-section view of the reference element taken along a line A-A′ shown in FIG. 2 according to an embodiment of the present disclosure. As shown in FIG. 3, the reference element 1 has a substrate 10 provided with a circuit structure, the reflective layer 80 is disposed on the substrate 10, and the supporting structures 20, the fence structure 30 and the sacrificial layer 50 are disposed on the reflective layer 80. It should be noted that the reflective layer 80 is a layer optionally disposed. The top surfaces of the supporting structures 20, the fence structure 30 and the sacrificial layer 50 are on the same plane and the infrared sensing structure 40 is disposed on the plane. More particularly, the supporting structures 20, the fence structure 30 and the sacrificial layer 50 may have the same height which is preferably 1-2 micrometers (μm). The circuit structures of the substrate 10, the reflective layer 80 (optionally disposed), the supporting structures 20 and the infrared sensing structure 40 may be electrically connected to each other as a whole circuit. There are openings 60 produced through etching on the infrared sensing structure 40 and the openings 60 correspond to the air gaps 70 between the supporting structures 20 and the fence structure 30 below. It should be noted that although the infrared sensing structure 40 seems to be separated into three parts, it is served to illustrate the existence of the openings 60, and the parts of the infrared sensing structure 40 may be connected to each other as shown in FIG. 1.

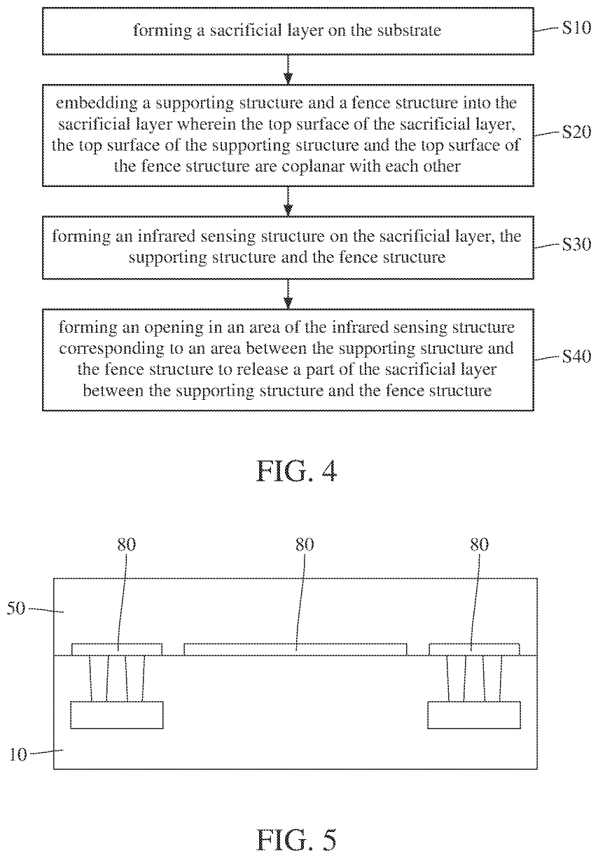

Please refer to FIG. 4 which is a flow chart of the manufacturing method of the reference element according to an embodiment of the present disclosure. As shown in FIG. 4, the manufacturing method of the reference element includes step S10: forming a sacrificial layer on the substrate; step S20: embedding a supporting structure and a fence structure into the sacrificial layer wherein the top surface of the sacrificial layer, the top surface of the supporting structure and the top surface of the fence structure are coplanar with each other; step S30: forming an infrared sensing structure on the sacrificial layer, the supporting structure and the fence structure; and step S40: forming an opening in an area of the infrared sensing structure corresponding to an area between the supporting structure and the fence structure to release a part of the sacrificial layer between the supporting structure and the fence structure.

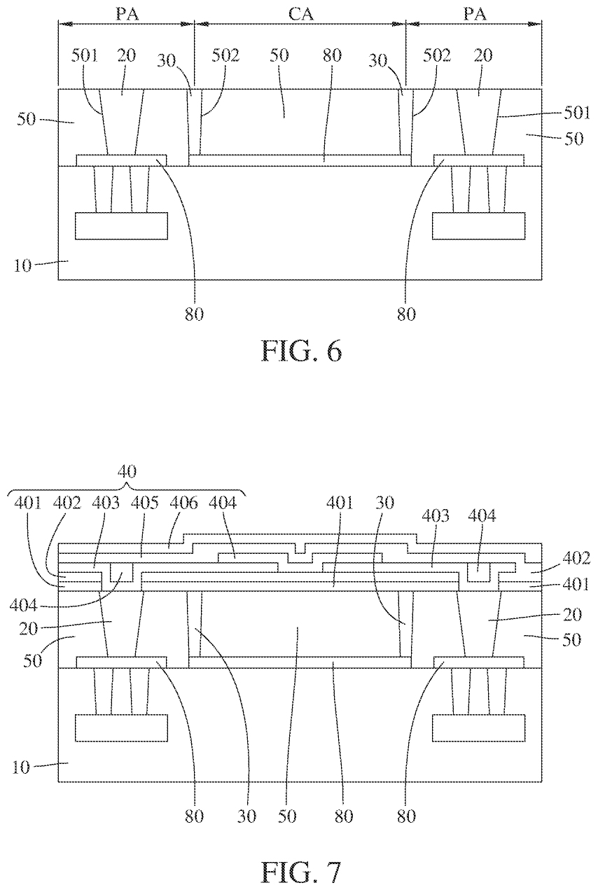

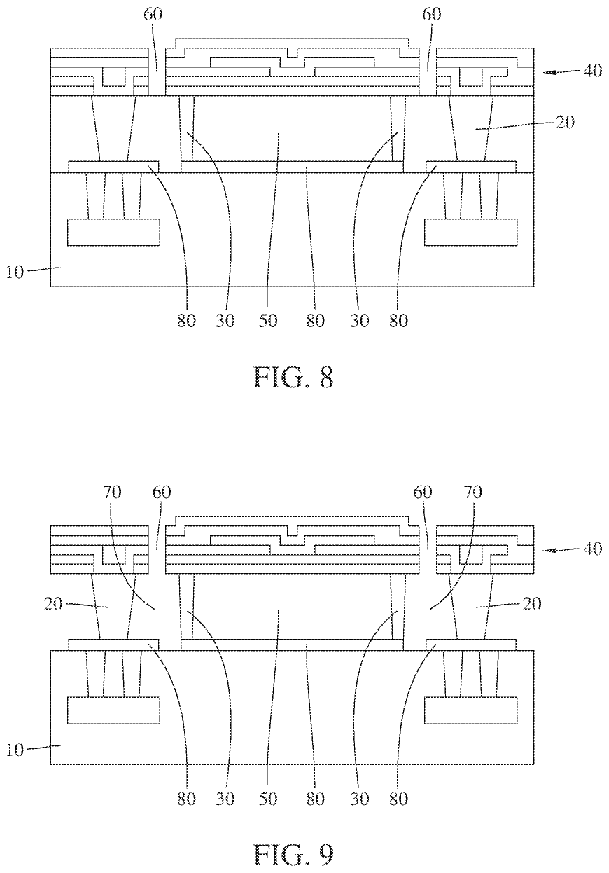

Please refer to FIG. 4 to FIG. 9 with schematic process illustrating each step of the manufacturing method of the reference element. FIG. 5 illustrates a schematic state of the reference element according to step S10 shown in FIG. 4. FIG. 6 illustrates a schematic state of the reference element according to step S20 shown in FIG. 4. FIG. 7 illustrates a schematic state of the reference element according to step S30 shown in FIG. 4. FIG. 8 and FIG. 9 illustrate two schematic states of the reference element according to step S40 shown in FIG. 4.

In the step S10, as shown in FIG. 5, a substrate 10 with a circuit structure is provided and a sacrificial layer 50 is formed on the substrate 10, wherein the material of the sacrificial layer 50 may be but is not limited to, for example, amorphous silicon, and the method of forming the sacrificial layer may be a deposition process. In this state, the sacrificial layer 50 is formed on the substrate 10. It should be noted that a pre-process may be optionally performed prior to the step S10, that is, to form a reflective layer 80 on the substrate 10 before forming the sacrificial layer 50. Specifically, the reflective layer 80 may be formed by depositing a metal layer (such as an aluminum layer of width of 300 nanometers) and patterning the metal layer through etching. In addition, after the reflective layer 80 is formed, a material of silicon oxide (SiOₓ) may be optionally formed on the surface of the reflective layer 80 to prevent the reflective layer 80 from being influenced by the material of the sacrificial layer 50. The patterning process may be a lithography process and/or an etching process.

In the step S20, as shown in FIG. 6, supporting structures 20 and a fence structure 30 are embedded into the sacrificial layer 50 wherein the top surface of the sacrificial layer 50, the top surface of the supporting structures 20 and the top surface of the fence structure 30 are coplanar with each other. Specifically, the step S20 may include several sub-steps such as a first sub-step to a fourth sub-step. The first sub-step is forming a plurality of through holes 501 and a groove 502 in the sacrificial layer 50, wherein the groove 502 passes through the sacrificial layer 50, divides the sacrificial layer 50 into a central area CA and a peripheral area PA and encloses the central area CA, and the through holes 501 are in the peripheral area PA. More particularly, the width of the top surface of one or each of the through holes 501 may equal the width of the top surface of the groove 502, wherein the width of the top surface of the through holes 501 may correspond to the width w1 of the top surface of the supporting structure 20 and the width of the top surface of the groove 502 may correspond to the width w2 of the top surface of the fence structure 30. The second sub-step is depositing a first material with conductivity (such as tungsten or other conductive material) in the through holes 501 to form the supporting structures 20. The third sub-step is depositing a second material with conductivity (such as tungsten or other conductive material) in the groove 502 to form the fence structure 30. More specifically, the first material and the second material may be the same material. Moreover, the second sub-step and the third sub-step may be conducted at the same time. The fourth sub-step is performing a planarization process on the top surface of the sacrificial layer 50, the top surfaces of the supporting structures 20 and the top surface of the fence structure 30 to ensure that the top surface of the sacrificial layer 50, the top surfaces of the supporting structures 20 and the top surface of the fence structure 30 are coplanar with each other with sufficient flatness. In particular, the supporting structures 20, the fence structure 30 and the sacrificial layer 50 may have the same height which is preferably 1-2 μm.

In step S30, as shown in FIG. 7, an infrared sensing structure 40 is formed on the supporting structures 20, the fence structure 30 and the sacrificial layer 50. The infrared sensing structure 40 may include two lower infrared absorption layers 401 and 402, a sensing electrode 403, an infrared sensing layer 404 and two upper infrared absorption layers 405 and 406. The area of the infrared sensing structure 40 corresponding to the projection of the sensing electrode 403 along the stacking direction may be defined as a sensing area, and the remaining area of the infrared sensing structure 40 may be defined as a light absorption area.

The lower infrared absorption layers 401 and 402 may be formed on the sacrificial layer 50 through deposition, wherein the lower infrared absorption layers 401 and 402 may be, for example, a silicon oxide layer and a silicon nitride layer respectively, and each have thickness of 40-100 nanometers (nm).

The sensing electrode 403 is formed on the lower infrared absorption layer 402. Specifically, after the formation of the lower infrared absorption layers 401 and 402, a part of lower infrared absorption layers 401 and 402 may be removed by etching to expose the supporting structures 20, or before the formation of the lower infrared absorption layers 401 and 402, the supporting structures 20 may be masked during the deposition process so as to be exposed after the completion of the deposition process. Next, a conductive layer (such as a titanium nitride layer with thickness of 50-100 nm) is deposited on the top surface of the lower infrared absorption layer 402 and the supporting structure 20 and the conductive layer is patterned to form the sensing electrode 403. The conductive layer surrounding the sensing electrode 403 is partially reserved to form the signal transmission circuit in the subsequent process. The patterning process may be a lithography process and/or an etching process.

The infrared sensing layer 404 is formed on the sensing electrode 403. Specifically, a layer of material with high resistance temperature coefficient (such as an amorphous silicon layer with thickness of 50-100 nm) is deposited on the sensing electrode 403 and the layer of material is patterned to form the infrared sensing layer 404 on the sensing electrode 403. The patterning process may be a lithography process and/or an etching process. In the drawings of the present disclosure, the infrared sensing layer 404 is exemplarily illustrated as being disposed on the sensing electrode 403, but in other embodiments, the sensing electrode may be disposed on the infrared sensing layer; that is, the sensing electrode may be formed after the formation of the infrared sensing layer.

The upper infrared absorption layers 405 and 406 are formed on the infrared sensing layer 404. Specifically, a silicon nitride layer (for example, with a thickness of 100-170 nm) is deposited to cover the infrared sensing layer 404 and the sensing electrode 403, a silicon oxide layer (for example, with a thickness of 40-100 nm) is deposited on the silicon nitride layer, and the silicon nitride layer and the silicon oxide layer are patterned through etching to form the upper infrared absorption layers 405 and 406. The upper infrared absorption layers 405 and 406 cover the top surface and side surface of the infrared sensing layer 404. The patterning process may be a lithography process and/or an etching process.

It should be noted that the above detailed structure and process of the infrared sensing structure are merely illustrative and do not intend to limit the infrared sensing structure provided in the reference element of the present disclosure. However, with the symmetrical configuration of the lower infrared absorption layer(s) and the upper infrared absorption layer(s) as mentioned above, the reference elements may be applied to prevent the occurrence of warpage or accumulating too much thermal stress so as to improve the production yield rate of the reference elements.

In step S40, as shown in FIG. 8 and FIG. 9, an opening 60 in an area of the infrared sensing structure 40 corresponding to an area between the fence structure 30 and each of the supporting structures 20 is formed to release a part of the sacrificial layer 50 between the fence structure 30 and each of the supporting structure 20 through the opening 60 and form an air gap 70. In this step, the area of the air gap 70 between the fence structure 30 and each of the supporting structures 20 corresponds to the peripheral area PA shown in FIG. 6, and the area surrounded by the fence structure 30 corresponds to the central area CA. The peripheral area PA of the sacrificial layer 50 is released from the openings 60 which are formed in the infrared sensing structure 40 above the peripheral area PA through the releasing process. In contrast, the central area CA of the sacrificial layer 50 is reserved since there is no opening above the central area CA and the central area CA is surrounded by the fence structure 30. The reserved area of the sacrificial layer 50 may increase the thermal contact area between the infrared sensing structure 40 and the substrate 10 to make the infrared sensing structure 40 sense the temperature of the substrate 10 more precisely.

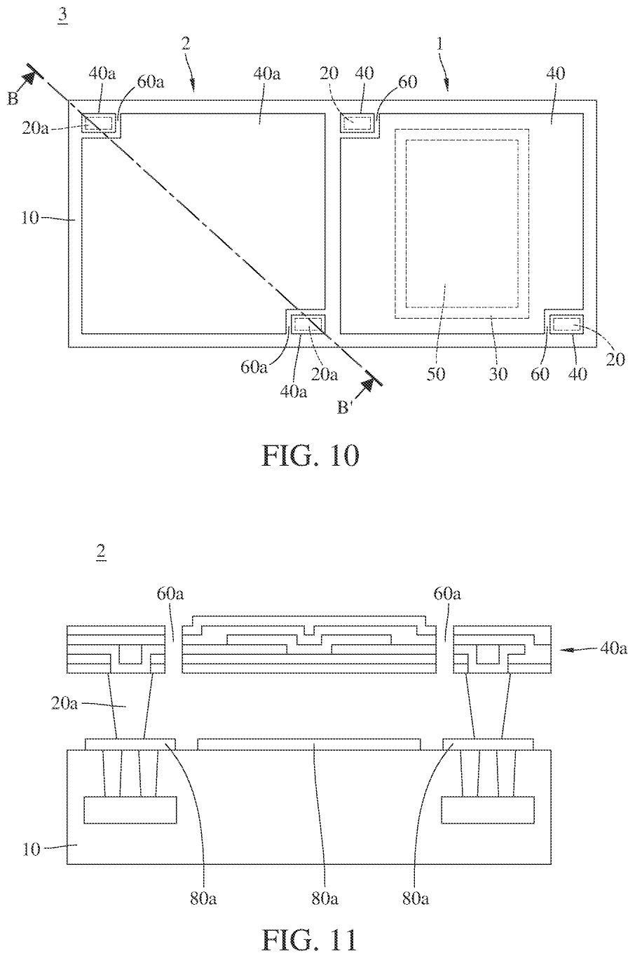

Please refer to FIG. 10 which illustrates a schematic top view of an infrared sensor according to an embodiment of the present disclosure. In the present embodiment, the infrared sensor 3 includes a reference element 1 and a sensing element 2. The reference element 1 may include structures mentioned in the above embodiments, including the substrate (hereinafter referred to as the first substrate), the supporting structures 20 (hereinafter referred to as the first supporting structures), the fence structure 30, the infrared sensing structure (hereinafter referred to as the first infrared sensing structure) 40 and the sacrificial layer 50, and the detailed structure is omitted here. The sensing element 2 may include the substrate (hereinafter referred to as the second substrate), the second supporting structures 20a and the second infrared sensing structure 40a. As shown in the figure, the first substrate and the second substrate may be the same substrate 10, while in another embodiment, the first substrate and the second substrate may be different substrates. As shown in FIG. 10, the second supporting structures 20a of the sensing element 2 are disposed on the first substrate 10, and the second infrared sensing structure 40a is disposed on the second supporting structures 20a and has the openings 60a. The second infrared sensing structure 40a may be similar to or same as the first infrared sensing structure 40, and the second supporting structures 20a may be similar to or same as the first supporting structures 20.

It should be noted that FIG. 10 merely schematically illustrates one reference element 1 and one sensing element 2, but in other embodiments, the number of the reference element 1 and the sensing element 2 may each be multiple, and the number of the reference element 1 may be different from the number of the sensing element 2. For example, the infrared sensor may include M×N sensing elements which form a matrix, and M+N reference elements which are disposed at two sides of the matrix, wherein M and N are natural numbers. In addition, the infrared sensing structure 40/40a and the openings 60/60a are illustrated in FIG. 10 in a simplified way. The actual configuration is that the infrared sensing structure 40/40a on the supporting structures 20/20a is electrically connected to the infrared sensing structure 40/40a located on the fence structure 30 as the infrared sensing structure 40 shown in FIG. 1.

Please refer to FIG. 3, FIG. 10 and FIG. 11, wherein FIG. 11 illustrates a schematic cross-section view of a sensing element of an infrared sensor taken along a line B-B′ shown in FIG. 10 according to an embodiment of the present disclosure. In the embodiment shown in FIG. 10, the cross-section of the reference element 1 along the diagonal may be as illustrated in FIG. 3, and the cross-section of the sensing element 2 along the diagonal may be as illustrated in FIG. 11. As shown in FIG. 11, the sensing element 2 includes a structure formed on the substrate 10 same as the substrate on which the structure of the reference element 1 is formed. The reflective layer 80a and the second supporting structures 20a are disposed on the substrate 10, and the second infrared sensing structure 40a is disposed on the second supporting structures 20a, wherein the reflective layer 80a is a layer optionally disposed.

Compared with the reference element 1 shown in FIG. 3, the second infrared sensing structure 40a is partly suspended on the substrate 10 but still maintains its flatness, and the second infrared sensing structure 40a and the first infrared sensing structure 40 of the reference element 1 are coplanar with each other. Specifically, the first supporting structures 20, the fence structure 30 and the sacrificial layer 50 of the reference element 1 may have the same height as that of the second supporting structures 20a of the sensing element 2 so that the first infrared sensing structure 40 and the second infrared sensing structure 40a are coplanar with each other, wherein the height is preferably 1-2 μm. The first supporting structures 20 and the fence structure 30 of the reference element 1 may be made of the same material as the second supporting structures 20a of the sensing element 2 made of, such as metal or other conductive material. The second supporting structures 20a with conductive material may be electrically connected to the second infrared sensing structure 40a. The second infrared sensing structure 40a, the second supporting structures 20a, the reflective layer 80a (optional), and the circuit structure of the substrate 10 may be electrically connected to each other as a whole circuit. That is to say, the reference element 1 and the sensing element 2 may have the same pattern of electrical connection paths. The second infrared sensing structure 40a has the openings 60a produced through etching. It should be noted that although the second infrared sensing structure 40a seems to be separated into three parts, it is served to illustrate the existence of the openings 60a, and the parts of the second infrared sensing structure 40a may be connected to each other as the infrared sensing structure 40 shown in FIG. 1.

According to the manufacturing method of the reference element 1 mentioned above, a manufacturing process of the infrared sensor 3 including the reference element 1 and the sensing element 2 is illustrated hereinafter, wherein the steps or the details similar or same as those of the method described above may be briefly described or omitted. The manufacturing process may include first to fourth steps. The first step is forming a sacrificial layer on a substrate, wherein a reflective layer may be optionally formed on the substrate before forming the sacrificial layer. The second step is embedding a first supporting structure(s), a second supporting structure(s) and a fence structure into the sacrificial layer wherein the top surface of the sacrificial layer, the top surface of the two supporting structures and the top surface of the fence structure are coplanar with each other, wherein the sacrificial layer may be divided into a first area for forming the reference element and a second area for forming the sensing element, and the first supporting structure and the fence structure are disposed in the first area and the second supporting structure is disposed in the second area without a fence structure. The third step is forming an infrared sensing structure on the sacrificial layer, the first and second supporting structures and the fence structure, wherein the infrared sensing structure includes a first infrared sensing structure disposed on the first supporting structure and the fence structure and a second infrared sensing structure disposed on the second supporting structure. The fourth step is forming an opening in an area of the infrared sensing structure corresponding to an area of the infrared sensing structure between each supporting structure and the fence structure to release a part of the sacrificial layer between each supporting structure and the fence structure and merely reserve the sacrificial layer enclosed in the fence structure. The sacrificial layer below the sensing element is completely released due to the lack of the fence structure so that the sensing element is suspended above the substrate through the second supporting structure.

As above described, the manufacturing process of the reference element is basically the same as that of the sensing element, and the reference element and the sensing element may be manufactured simultaneously without an additional mask. Moreover, the height of the reference element may be the same as that of the sensing element so that the process of the whole infrared sensor may have good uniformity to improve the production yield rate. In addition, the reference element and the sensing element may have the same pattern of electrical connection paths, thereby reducing the electrical deviation of the reference element.

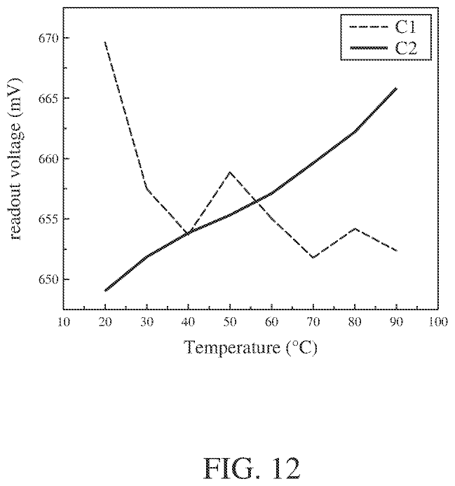

Please refer to FIG. 12 which illustrates a relationship between the temperature to be measured and the readout voltage under the circumstance that the reference element according to an embodiment of the present disclosure is used or not. The chart records the relationship between the temperature to be measured and the readout voltage. The data C1 is not calibrated by the reference element of the embodiment mentioned above, and is recorded by directly subtracting the voltage readout values of illuminated and unilluminated light. The data C2 is a readout voltage calibrated by the reference element. The comparison indicates that the data C2 calibrated by the reference element has a more highly correlated relationship between the temperature of the object to be measured and the readout voltage. That is, with the temperature of the object to be measured getting higher, the readout voltage is also higher. On the contrary, the data C1 without calibration by the reference element cannot reflect the actual temperature of the object to be measured through the readout voltage. In other words, the infrared sensor with the reference element of the embodiments described above may have a higher measuring precision over the infrared sensor without the reference element.

In view of the above description, the reference element of the infrared sensor, the infrared sensor, and the manufacturing method of the reference element of the infrared sensor of the present disclosure may stack up the reference element through the sacrificial layer and the fence structure to dispose the reference element and the sensing element on the same plane and ensure good thermal contact between the reference element and the substrate. In addition, the reference element and the sensing element may be manufactured under one set of process, and the operation height during the process may remain the same with lower process variation, thereby improving the stability and yield rate of the process. Also, the reference element and the sensing element may have the same pattern of electrical connection paths, thereby reducing the electrical deviation of the reference element and having a better circuit compensation calibration.

What is claimed is:

1. A reference element of an infrared sensor, comprising:
a substrate;
a sacrificial layer disposed on the substrate;
a supporting structure disposed on the substrate, wherein a top surface of the supporting structure is coplanar with a top surface of the sacrificial layer;
a fence structure disposed on the substrate and surrounding the sacrificial layer, with a top surface of the fence structure being coplanar with the top surface of the sacrificial layer, and an air gap being between the fence structure and the supporting structure; and
an infrared sensing structure disposed on the sacrificial layer, the supporting structure and the fence structure, and having an opening corresponding to the air gap.

2. The reference element of the infrared sensor of claim 1, wherein the supporting structure is made of a conductive material and electrically connected to the infrared sensing structure.

3. The reference element of the infrared sensor of claim 1, wherein the supporting structure and the fence structure are made of a same material.

4. The reference element of the infrared sensor of claim 1, further comprising a reflective layer disposed between the sacrificial layer and the substrate.

5. The reference element of the infrared sensor of claim 1, wherein the supporting structure, the fence structure and the sacrificial layer have a same height.

6. The reference element of the infrared sensor of claim 5, wherein the height is 1-2 micrometers.

7. The reference element of the infrared sensor of claim 1, wherein the top surface of the supporting structure and the top surface of the fence structure have a same width.

8. An infrared sensor, comprising:
a reference element, comprising:
a first substrate;
a sacrificial layer disposed on the first substrate;
a first supporting structure disposed on the first substrate, wherein a top surface of the first supporting structure is coplanar with a top surface of the sacrificial layer;
a fence structure disposed on the first substrate and surrounding the sacrificial layer, with a top surface of the fence structure being coplanar with the top surface of the sacrificial layer, and an air gap being between the fence structure and the first supporting structure; and
a first infrared sensing structure disposed on the sacrificial layer, the first supporting structure and the fence structure and having an opening corresponding to the air gap; and
a sensing element, comprising:
a second substrate;
a second supporting structure disposed on the second substrate; and
a second infrared sensing structure disposed on the second supporting structure;
wherein the first infrared sensing structure and the second infrared sensing structure are coplanar with each other.

9. The infrared sensor of claim 8, wherein the first supporting structure and the second supporting structure are made of a conductive material, the first supporting structure is electrically connected to the first infrared sensing structure, and the second supporting structure is electrically connected to the second infrared sensing structure.

10. The infrared sensor of claim 8, wherein the first supporting structure, the second supporting structure and the fence structure are made of a same material.

11. The infrared sensor of claim 8, wherein the first supporting structure, the second supporting structure, the fence structure and the sacrificial layer have a same height.

12. The infrared sensor of claim 11, wherein the height is 1-2 micrometers.

13. The infrared sensor of claim 8, wherein the top surface of the first supporting structure and the top surface of the fence structure have a same width.

14. A manufacturing method of a reference element of an infrared sensor, comprising:
forming a sacrificial layer on a substrate;
embedding a supporting structure and a fence structure into the sacrificial layer, wherein a top surface of the sacrificial layer, a top surface of the supporting structure and a top surface of the fence structure are coplanar with each other;
forming an infrared sensing structure on the sacrificial layer, the supporting structure and the fence structure; and
forming an opening in an area of the infrared sensing structure corresponding to an area between the supporting structure and the fence structure to release a part of the sacrificial layer between the supporting structure and the fence structure.

15. The manufacturing method of the reference element of the infrared sensor of claim 14, wherein embedding the supporting structure and the fence structure into the sacrificial layer wherein the top surface of the sacrificial layer, the top surface of the supporting structure and the top surface of the fence structure are coplanar with each other comprises:
forming a plurality of through holes and a groove which passes through the sacrificial layer, divides the sacrificial layer into a central area and a peripheral area and encloses the central area, wherein the plurality of through holes are in the peripheral area;
depositing a first material in the plurality of through holes to form the supporting structure;
depositing a second material in the groove to form the fence structure; and
performing a planarization process on the top surface of the sacrificial layer, the top surface of the supporting structure and the top surface of the fence structure.

16. The manufacturing method of the reference element of the infrared sensor of claim 15, wherein each of a height of the sacrificial layer, a height of the supporting structure and a height of the fence structure is 1-2 micrometers.

17. The manufacturing method of the reference element of the infrared sensor of claim 15, wherein a top surface of one of the plurality of through holes and the top surface of the groove have a same width.

18. The manufacturing method of the reference element of the infrared sensor of claim 15, wherein the first material is a conductive material.

19. The manufacturing method of the reference element of the infrared sensor of claim 15, wherein the first material is the same as the second material.

20. The manufacturing method of the reference element of the infrared sensor of claim 14, further comprising:
forming a reflective layer on the substrate before forming the sacrificial layer.
